(19) United States
(12) Patent Application Publication
(10) Pub. No.: US 2024/0073968 A1
(43) Pub. Date: Feb. 29, 2024

(54) METHOD AND APPARATUS FOR HANDLING FALLBACK OF DATA TRANSMISSION

(71) Applicant: Lenovo (Beijing) Limited, Beijing (CN)

(72) Inventors: Ran Yue, Beijing (CN); Yi Zhang, Beijing (CN); Jie Shi, Beijing (CN); Min Xu, Beijing (CN); Jie Hu, Beijing (CN)

(73) Assignee: Lenovo (Beijing) Limited, Beijing (CN)

(21) Appl. No.: 18/271,761

(22) PCT Filed: Jan. 13, 2021
(86) PCT No.: PCT/CN2021/071498

§ 371 Date: Jul. 11, 2023

(51) Int. Cl. H04W 76/10; H04W 74/08

(52) U.S. Cl. CPC H04W 76/10; H04W 74/0833

(57) ABSTRACT

The present application relates to a method and an apparatus for fallback of data transmission. The method includes: detecting a trigger condition relating to a wireless network characteristic, while the user equipment is in a non-connected RRC state with a network device; and controlling a data transmission according to the detection of the trigger condition.

### TECHNICAL FIELD

Embodiments of the present application generally relate to wireless communication technology, especially to a method and an apparatus for handling fallback of data transmission under 3 GPP (3rd Generation Partnership Project) 5G New Radio (NR).

### BACKGROUND

In network of 3rd Generation Partnership Project (3GPP) 5G New Radio (NR), beam failure detection (BFD) and beam failure recovery (BFR) are supported in some types of data transmission. Nevertheless, in some other types of data transmission (e.g., small data transmission), to avoid unnecessary complexity of computation, BFD and BFR may not be supported. However, specific details of handling fallback of data transmission without BFD and BFR have not been discussed yet and there are still some issues that need to be solved.

### SUMMARY

Some embodiments of the present application provide a method for a user equipment (UE). The method includes: detecting a trigger condition relating to a wireless network characteristic, while the user equipment is in a non-connected radio resource (RRC) state with a network device; and controlling a data transmission according to the detection of the trigger condition.

Some embodiments of the present application provide an apparatus. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method for wireless communications.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2A illustrates a schematic diagram of message transmissions in accordance with some embodiments of the present application.

FIG. 2B illustrates a schematic diagram of message transmissions in accordance with some embodiments of the present application.

FIG. 3A illustrates a schematic diagram of message transmissions in accordance with some embodiments of the present application.

FIG. 3B illustrates a schematic diagram of message transmissions in accordance with some embodiments of the present application.

FIG. 4 illustrates a flow chart of a method for wireless communications according to an embodiment of the present disclosure.

FIGS. 5A to 5E illustrate flow charts of a method for wireless communications according to an embodiment of the present disclosure.

FIG. 6 illustrates a flow chart of a method for wireless communications according to an embodiment of the present disclosure.

FIGS. 7A to 7C illustrate flow charts of a method for wireless communications according to an embodiment of the present disclosure.

FIG. 8 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. Embodiments of the present application may be provided in a network architecture that adopts various service scenarios, for example but is not limited to, 3GPP 3G, long-term evolution (LTE), LTE-Advanced (LTE-A), 3GPP 4G, 3GPP 5G NR (new radio), etc. It is contemplated that along with the 3GPP and related communication technology development, the terminologies recited in the present application may change, which should not affect the principle of the present application.

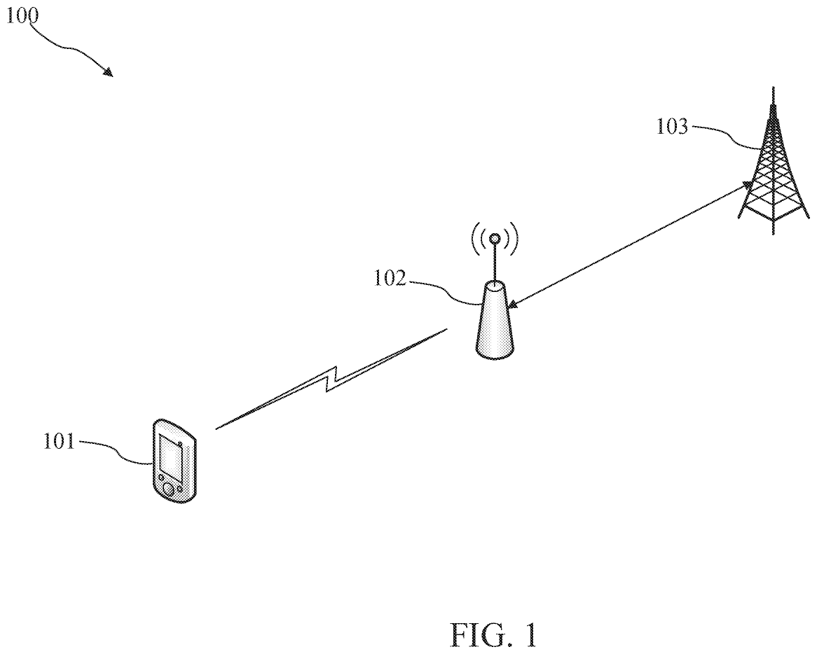

Referring to FIG. 1, a wireless communication system 100 may include a user equipment (UE) 101, a base station (BS) 102 and a core network (CN) 103. Although a specific number of the UE 101, the BS 102 and the CN 103 are depicted in FIG. 1, it is contemplated that any number of the UEs 101, the BSs 102 and the CNs 103 may be included in the wireless communication system 100.

The CN 103 may include a core Access and Mobility management Function (AMF) entity. The BS 102, which may communicate with the CN 103, may operate or work under the control of the AMF entity. The CN 103 may further include a User Plane Function (UPF) entity, which communicatively coupled with the AMF entity.

The BS 102 may be distributed over a geographic region. In certain embodiments of the present application, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally part of a radio access network that may include one or more controllers communicably coupled to one or more corresponding B S(s).

The UE 101 may include, for example, but is not limited to, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), Internet of Thing (IoT) devices, or the like.

According to some embodiments of the present application, the UE 101 may include, for example, but is not limited to, a portable wireless communication device, a smart phone, a cellular telephone, a flip phone, a device having a subscriber identity module, a personal computer, a selective call receiver, a wireless sensor, a monitoring device, or any other device that is capable of sending and receiving communication signals on a wireless network.

In some embodiments of the present application, the UE 101 may include, for example, but is not limited to, wearable devices, such as smart watches, fitness bands, optical head-mounted displays, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE 101 may communicate directly with the BS 102 via uplink communication signals.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 3GPP-based network, a 3GPP 5G network, a satellite communications network, a high altitude platform network, and/or other communications networks.

In some embodiments of the present application, the wireless communication system 100 is compatible with the 5G New Radio (NR) of the 3GPP protocol or the 5G NR-light of the 3GPP protocol, wherein the BS 102 transmits data using an OFDM modulation scheme on the downlink (DL) and the UE 101 transmits data on the uplink (UL) using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, the UE 101 and BS 102 may communicate using other communication protocols, such as the IEEE 802.11 family of wireless communication protocols. Further, in some embodiments of the present application, the UE 101 and BS 102 may communicate over licensed spectrums, whereas in other embodiments, the UE 101 and BS 102 may communicate over unlicensed spectrums. The present application is not intended to be limited to the implementation of any particular wireless communication system architecture or protocol. In yet some embodiments of present application, the BS 102 may communicate with the UE 101 using the 3GPP 5G protocols.

According to some existing agreements, beam failure detection (BFD) and beam failure recovery (BFR) are supported in some types of data transmission. Nevertheless, in some other types of data transmission (e.g., small data transmission, SDT), to avoid unnecessary complexity of computation, BFD and BFR may not be supported. However, specific details of handling fallback of data transmission without BFD and BFR have not been discussed yet and there are still some issues that need to be solved.

Accordingly, in the present disclosure, details of handling fallback of data transmission without BFD and BFR with different network conditions will be introduced. More details on embodiments of the present disclosure will be further described hereinafter.

Particularly, level one (L1) beam management or radio link monitoring may be performed by UE 101, but BFD and BFR may not be supported. Then, UE 101 may detect a trigger condition when UE 101 is under a non-connected state. The trigger condition may be related to a wireless network characteristic. The trigger condition relating to the wireless network characteristic may include reduction in received beam quality or availability of pre-configured uplink resource(s). According to the detection of the trigger condition, UE 101 may control data transmission between UE 101 and BS 102.

In some embodiments, the trigger condition may include that: (1) a beam quality is less than a threshold; (2) the pre-configured uplink resource(s) is/are not available; or (3) the pre-configured uplink resource(s) is/are released. The data transmission between UE 101 and BS 102 may include configured grant type one (i.e., CG type 1 defined in 3GPP specification) based small data transmission (SDT), and UE 101 may control the data transmission as performing a fallback to a random access channel (RACH) based SDT from the CG type 1 based SDT.

In some implementations, when UE 101 is under the non-connected state (e.g., RRC_IDLE state or RRC_INACTIVE state defined in 3GPP specification), UE 101 may detect, by a lower layer (i.e., physical layer, PHY layer), the trigger condition of that: (1) beam quality(s) (e.g., downlink beam quality) is/are less than a threshold (i.e., beam quality(s) is/are not good enough); (2) the pre-configured uplink resource(s) between UE 101 and BS 102 is/are not available; or (3) the pre-configured uplink resource(s) is/are released. Then, UE 101 may perform the fallback to the RACH based SDT from the CG type 1 based SDT according to the detection of the trigger condition.

More specifically, when the PHY layer of UE 101 detects that:
(a) none of the pre-configure resource(s) for SDT is/are good enough (i.e., none of beam quality(s) of the pre-configure resource(s) for SDT is/are greater than a threshold);
(b) all of transmission attempt(s) on the pre-configure resource(s) for SDT are failure;
(c) all reference signal receiving powers (RSRPs) of the pre-configure resource(s) for SDT are lower than a threshold;
(d) counting number of bad downlink beam (i.e., downlink beam with low quality) is greater than a threshold;
(e) counting number of bad downlink beam (i.e., downlink beam with low quality) is greater than a threshold during a period of time;
(f) counting number of bad downlink beam/beam set (i.e., downlink beam/beam set with low quality) which is associated with the pre-configured resource(s) for SDT is greater than a threshold; or
(g) counting number of bad downlink beam/beam set (i.e., downlink beam/beam set with low quality) which is associated with the pre-configured resource(s) for SDT is greater than a threshold during a period of time,
   the PHY layer of UE 101 may send an indication to an upper layer (i.e., media access control layer, MAC layer) of UE 101.

Then, according to the indication, the MAC layer of UE 101 may perform the fallback to the RACH based SDT from the CG type 1 based SDT. It should be noted that, in some implementations, the MAC layer of UE 101 may perform the fallback to a RACH procedure (e.g., legacy RACH procedure) from the CG type 1 based SDT according to the indication. To perform the RACH procedure or to perform the RACH based SDT may be pre-configured or be selected by the UE 101.

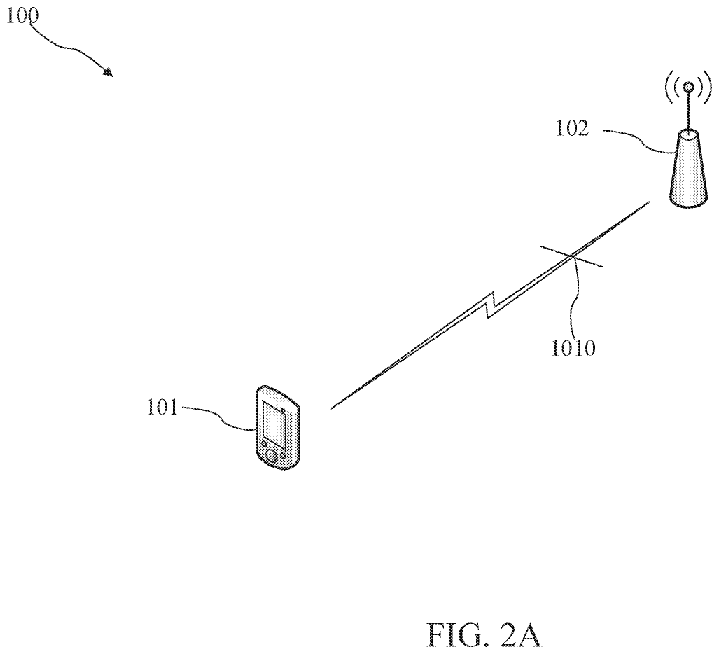

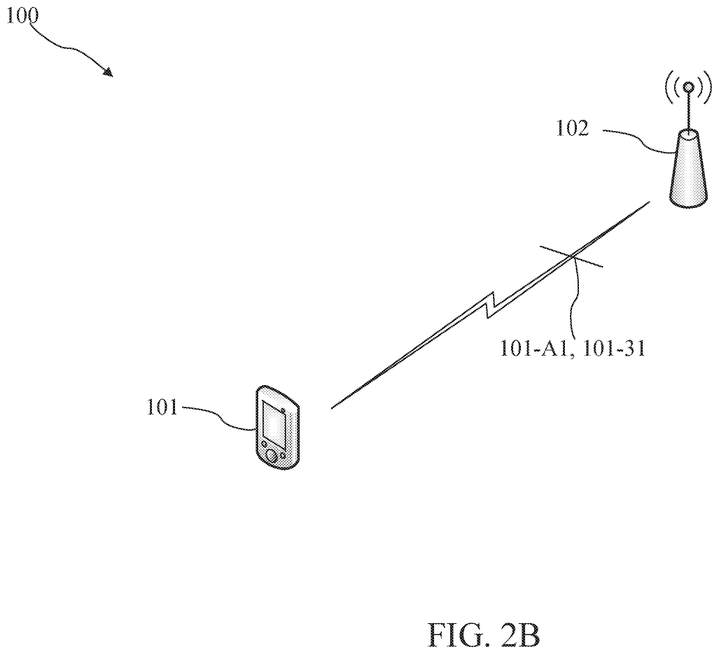

In some embodiments, UE 101 may inform BS 102 of that the fallback to the RACH based SDT from the CG type 1 based SDT is triggered by the PHY layer of UE 101. In some implementations, a new radio resource control (RRC) cause value may be introduced for informing BS 102 of the fallback to the RACH based SDT. Please refer to FIG. 2A, in detail, UE 101 may transmit an RRC message 1010 to BS 102. The RRC message 1010 may include an RRC cause indicating the cause of the control of the data transmission. More specifically, the RRC cause may include a resume cause value indicating that the cause of that the fallback to the RACH based SDT from the CG type 1 based SDT is triggered by the PHY layer of UE 101.

For example, the RRC cause (e.g., parameter “ResumeCause” defined in 3GPP specification) includes a new defined resume cause value of “fallback to the RACH based SDT according to that the beam quality is less than the threshold” for indicating the cause of the fallback to the RACH based SDT from the CG type 1 based SDT is triggered by the PHY layer of UE 101 according to that the beam quality is less than the threshold.

For another example, the RRC cause (e.g., parameter “ResumeCause” defined in 3GPP specification) includes a new defined resume cause value of “SDT CG beam failure” for indicating that the cause of the fallback to the RACH based SDT from the CG type 1 based SDT is triggered by the PHY layer of UE 101 according to that the pre-configured uplink resource(s) is/are not available or according to that the pre-configured uplink resource(s) is/are not available.

In some implementations, an access category (AC) may be introduced for checking whether the access attempt for the fallback to the RACH based SDT is allowed by the BS 102. In detail, an AC may be mapped to a resume cause value of an RRC cause, and the resume cause value may indicate that the cause of the fallback to the RACH based SDT from the CG type 1 based SDT is triggered by the PHY layer of UE 101. Therefore, the AC may be selected by UE 101 when the fallback to the RACH based SDT from the CG type 1 based SDT is triggered by the PHY layer of UE 101.

For example, AC “Y” is a new defined AC value. The mapping relation between AC “Y” and the resume cause value “fallback to RACH based SDT according to that the beam quality is less than the threshold” is defined. UE 101 selects AC “Y” when the fallback to RACH based SDT is indicated by the PHY layer of UE 101.

More specifically, when the PHY layer of UE 101 indicates to initialize the fallback RACH based SDT according to that the beam quality is less than the threshold, an access barring check is performed by UE 101 according to AC “Y” and corresponding broadcast message from BS 102. When the present access attempt is considered as allowed, the resume cause value “fallback to RACH based SDT according to that the beam quality is less than the threshold” is included in message-A (i.e., MSG-A of RACH procedure defined in 3GPP specification) 101-A1 or message-3 of (i.e., MSG-3 of RACH procedure defined in 3GPP specification) 101-31 by UE 101 while UE 101 performs the fallback RACH based SDT. Then, refer to FIG. 2B, UE 101 transmits message-A 101-A1 and message-3 101-31 to BS 102.

For example, an existed AC is utilized. The mapping relation between the existed AC and the resume cause value “fallback to RACH based SDT according to that the beam quality is less than the threshold” is defined. UE 101 selects the existed AC when the fallback to RACH based SDT is indicated by the PHY layer of UE 101.

When the PHY layer of UE 101 indicates to initialize the fallback RACH based SDT according to that the beam quality is less than the threshold, an access barring check is performed according to the existed AC and corresponding broadcast message from BS 102. When the present access attempt is considered as allowed, the resume cause value “fallback to RACH based SDT according to that the beam quality is less than the threshold” is included in message-A 101-A1 or message-3 101-31 by UE 101 while UE 101 performs the fallback RACH based SDT. Then, UE 101 transmits message-A 101-A1 and message-3 101-31 to BS 102.

In some implementations, an access identity (AI) may be introduced for checking whether the access attempt for the fallback to the RACH based SDT is allowed by the BS 102. In detail, an AI may be mapped to a resume cause value of an RRC cause, and the resume cause value may indicate that the cause of the fallback to the RACH based SDT from the CG type 1 based SDT is triggered by the PHY layer of UE 101. Therefore, the AI may be indicated, determined or selected by UE 101 when the fallback to the RACH based SDT from the CG type 1 based SDT is triggered by the PHY layer of UE 101.

For example, AI “K” is a new defined AC value. The mapping relation between AI “K” and the resume cause value “fallback to RACH based SDT according to that the beam quality is less than the threshold” is defined. UE 101 indicates, selects or determines AI “K” when the fallback to RACH based SDT is indicated by the PHY layer of UE 101.

For example, an existed AI is utilized. The mapping relation between the existed AI and the resume cause value “fallback to RACH based SDT according to that the beam quality is less than the threshold” is defined. UE 101 indicates, selects or determines the existed AI when the fallback to RACH based SDT is indicated by the PHY layer of UE 101.

In some implementations, a new RRC establishment cause value may be introduced for informing BS 102 of the fallback to the RACH based SDT. In detail, UE 101 may transmit an RRC message to BS 102. The RRC message may include an RRC establishment cause indicating the cause of the control of the data transmission. More specifically, the RRC establishment cause may include an establishment cause value indicating that the cause of that the fallback to the RACH based SDT from the CG type 1 based SDT is triggered by the PHY layer of UE 101.

For ease of understanding, a possible procedure is demonstrated as follows:
(1) a resume cause value “fallback to RACH based SDT according to that the beam quality is less than the threshold” is added to a set of resume cause value;
(2) AC=“Y” is defined for the fallback RACH based SDT caused by that the beam quality is less than the threshold; and/or AI=“K” is defined for the fallback RACH based SDT; the mapping relation is defined for the AC “Y” and/or AI “K” and the resume cause value “fallback to RACH based SDT according to that the beam quality is less than the threshold”;
(3) UE 101 is configured with uplink pre-configured resources for SDT and UE 101 is able to perform RACH based SDT;
(4) Network broadcast message, RRC release message or RRC configure/re-configure message includes the related unified access control (UAC) parameters of fallback RACH based SDT for beam quality;
(5) Network broadcast message, RRC Release message or RRC configure/re-configure message indicates that the CG type1 based SDT and RACH based SDT are supported by cell of BS 102;
(6) UE 101 is indicated to fall back to the RACH based SDT according to that the beam quality is less than the threshold;
(7) UE 101 selects “Y” as AC; UE selects (or non-access stratum (NAS) determines) the access identity(s) when the fallback RACH based SDT is triggered;
(8) after the access barring check according to the new parameters (i.e., new introduced AC and AI) and the corresponding broadcast message, for example the barring factor corresponding to the AC and/or AI, the present access attempt is considered as allowed;
(9) UE 101 initials a RACH based SDT and the resume cause for the fallback RACH based SDT is set to “fallback to RACH based SDT according to that the beam quality is less than the threshold”.

It should be noted that, in some cases, when no SDT is initialized, the PHY layer of UE 101 indicates the MAC layer to initialize a RACH, and the resume cause value is set to “resume RRC connection according to that the beam quality is less than the threshold”. In some cases, UE 101 may select to perform the RACH based SDT or the legacy RACH, and the resume cause value is set to “fallback to RACH based SDT according to that the beam quality is less than the threshold” or “resume RRC connection according to that the beam quality is less than the threshold”.

In some implementations, when UE 101 attempts to perform the RACH based SDT according to that the beam quality is less than the threshold, BS 102 may directly consider the present access attempt for the RACH based SDT as allowed.

In some embodiments, when the fallback RACH based SDT is indicated by the PHY layer of UE 101, data of the data transmission stored in a hybrid automatic repeat request (HARQ) buffer of HARQ process, which is associated with pre-configured uplink resources for SDT, may need to be kept (i.e., may not be flushed) and may need to be transmitted by the subsequent RACH based SDT.

Accordingly, UE 101 may obtain the data of the data transmission stored in the HARQ buffer when the fallback to the RACH based SDT is performed. Then, UE 101 may store the data in another buffer. In some implementations, the another buffer may be dedicated for message-3 of RACH procedure (i.e., MSG-3 of RACH procedure defined in 3GPP specification) or message-A of RACH procedure (i.e., MSG-A of RACH procedure defined in 3GPP specification). In some implementations, the another buffer may be dedicated for message-3 of RACH based SDT procedure or message-A of RACH based SDT procedure.

In some implementations, when the data stored in HARQ buffer includes a first media access control protocol data unit (MAC PDU) and a size of the first MAC PDU is not the same (i.e., great than or less than) as a size of the another buffer, UE 101 may obtain a media access control service data unit (MAC SDU) from the first MAC PDU and include the MAC SDU in a second MAC PDU for the size of the another buffer.

For example, UE 101 indicates to a multiplexing and assembly entity to obtain MAC sub-PDU(s) carrying the MAC SDU from the first MAC PDU and to include the MAC SDU in the second MAC PDU for the subsequent RACH based SDT.

In some embodiments, the trigger condition may include that: (1) the beam quality is less than a threshold; (2) the pre-configured uplink resource(s) is/are not available; or (3) the pre-configured uplink resource(s) is/are released. The data transmission between UE 101 and BS 102 may include CG type 1 based SDT, and UE 101 may control the data transmission as performing a RACH procedure (e.g., legacy RACH procedure) when a fallback to RACH based SDT is not supported.

In some implementations, when UE 101 is under the non-connected state (e.g., RRC_IDLE state or RRC_INACTIVE state defined in 3GPP specification), UE 101 may detect, by the lower layer (i.e., physical layer, PHY layer), the trigger condition of that: (1) beam quality(s) (e.g., downlink beam quality) is/are less than a threshold (i.e., beam quality(s) is/are not good enough); (2) the pre-configured uplink resource(s) between UE 101 and BS 102 is/are not available; or (3) the pre-configured uplink resource(s) is/are released. Then, UE 101 may perform the RACH procedure according to the detection of the trigger condition.

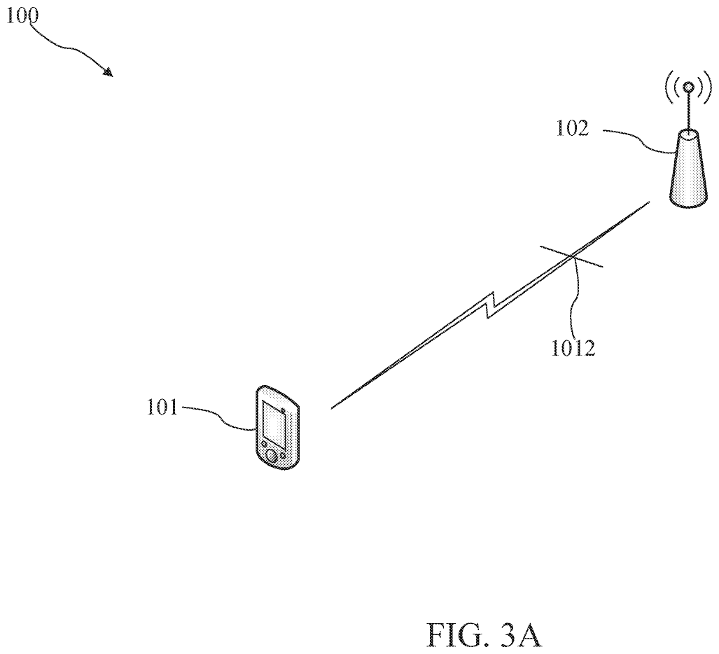

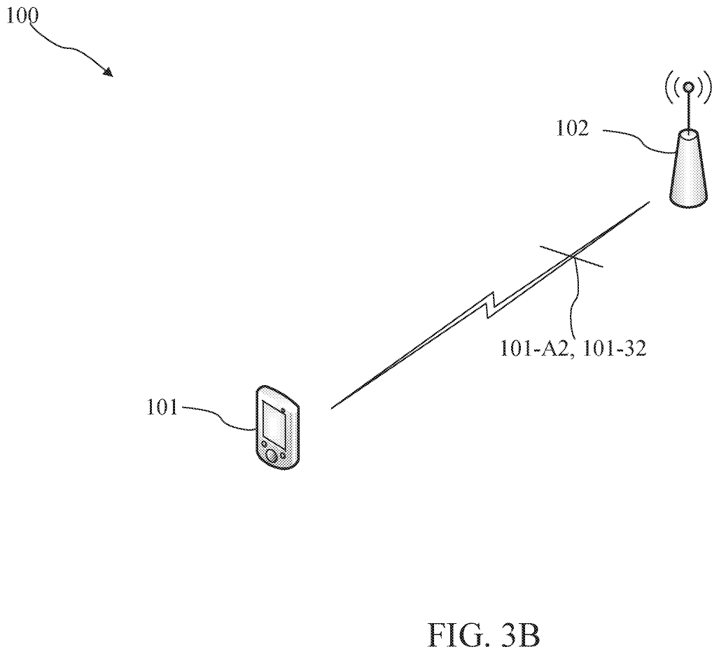

In some embodiments, UE 101 may inform BS 102 of that the RACH procedure is triggered by the PHY layer of UE 101. In some implementations, a new RRC cause value may be introduced for informing BS 102 of the RACH procedure. Please refer to FIG. 3A, in detail, UE 101 may transmit an RRC message 1012 to BS 102. The RRC message 1012 may include an RRC cause indicating the cause of the control of the data transmission. More specifically, the RRC cause may include an establishment cause value indicating that the cause of that the RACH procedure is triggered by the PHY layer of UE 101.

For example, the RRC cause (e.g., parameter “EstablishmentCause” defined in 3GPP specification) includes a new defined establishment cause value of “resume RRC connection according to that the beam quality is less than the threshold” for indicating the cause of the RACH procedure is triggered by the PHY layer of UE 101 according to that the beam quality is less than the threshold.

For another example, the RRC cause (e.g., parameter “EstablishmentCause” defined in 3GPP specification) includes a new defined establishment cause value of “SDT CG beam failure” for indicating that the cause of the RACH procedure is triggered by the PHY layer of UE 101 according to that the pre-configured uplink resource(s) is/are not available or according to that the pre-configured uplink resource(s) is/are not available.

In some implementations, an AC may be introduced for checking whether the access attempt for the RACH procedure is allowed by BS 102. In detail, an AC may be mapped to an establishment cause value of an RRC cause, and the establishment cause value may indicate that the cause of the RACH procedure is triggered by the PHY layer of UE 101. Therefore, the AC may be selected by UE 101 when the RACH procedure is triggered by the PHY layer of UE 101.

For example, AC “Z” is a new defined AC value. The mapping relation between AC “Z” and the establishment cause value “setup RRC connection according to that the beam quality is less than the threshold” is defined. UE 101 selects AC “Z” when the RACH procedure is indicated by the PHY layer of UE 101.

More specifically, when the PHY layer of UE 101 indicates to initialize the RACH procedure according to that the beam quality is less than the threshold, an access barring check is performed by UE 101 according to AC “Z” and corresponding broadcast message from BS 102. When the present access attempt is considered as allowed, the establishment cause value “setup RRC connection according to that the beam quality is less than the threshold” is included in message-A (i.e., MSG-A of RACH procedure defined in 3GPP specification) 101-A2 or message-3 of (i.e., MSG-3 of RACH procedure defined in 3GPP specification) 101-32 by UE 101 while UE 101 performs the RACH procedure. Then, refer to FIG. 3B, UE 101 transmits message-A 101-A2 and message-3 101-32 to BS 102.

For example, an existed AC is utilized. The mapping relation between the existed AC and the establishment cause value “setup RRC connection according to that the beam quality is less than the threshold” is defined. UE 101 selects the existed AC when the RACH procedure is indicated by the PHY layer of UE 101.

When the PHY layer of UE 101 indicates to initialize the RACH procedure according to that the beam quality is less than the threshold, an access barring check is performed according to the existed AC and corresponding broadcast message from BS 102. When the present access attempt is considered as allowed, the establishment cause value “setup RRC connection according to that the beam quality is less than the threshold” is included in message-A 101-A2 or message-3 101-32 by UE 101 while UE 101 performs the RACH procedure. Then, UE 101 transmits message-A 101-A2 and message-3 101-32 to BS 102.

In some implementations, an AI may be introduced for checking whether the access attempt for the RACH procedure is allowed by BS 102. In detail, an AI may be mapped to an establishment cause value of an RRC cause, and the establishment cause value may indicate that the cause of the RACH procedure is triggered by the PHY layer of UE 101. Therefore, the AI may be indicated, determined or selected by UE 101 when the RACH procedure is triggered by the PHY layer of UE 101.

For example, AI “K” is a new defined AC value. The mapping relation between AI “K” and the establishment cause value “setup RRC connection according to that the beam quality is less than the threshold” is defined. UE 101 indicates, selects or determines AI “K” when the RACH procedure is indicated by the PHY layer of UE 101.

For example, an existed AI is utilized. The mapping relation between the existed AI and the establishment cause value “setup RRC connection according to that the beam quality is less than the threshold” is defined. UE 101 indicates, selects or determines the existed AC when the RACH procedure is indicated by the PHY layer of UE 101.

For ease of understanding, a possible procedure is demonstrated as follows:
(1) an establishment cause value “setup RRC connection according to that the beam quality is less than the threshold” is added to the set of establishment cause value;
(2) AC=“Z” is defined for the RACH procedure caused by that the beam quality is less than the threshold; and/or AI=“M” is defined for the RACH procedure caused by that the beam quality is less than the threshold; and/or the mapping relation is defined for AC-“Z” and/or AI=“M” and the establishment cause value “setup RRC connection according to that the beam quality is less than the threshold”;
(3) UE 101 is configured with uplink pre-configured resources for SDT;
(4) Network broadcast message, RRC release message or RRC configure/re-configure message includes the related UAC parameters of the RACH procedure caused by that the beam quality is less than the threshold;
(5) UE 101 is indicated to initialize the RACH procedure according to that the beam quality is less than the threshold;
(6) UE 101 selects “Z” as AC; UE 101 selects (or non-access stratum (NAS) determines) AI(s) when the RACH procedure is triggered;
(7) after the access barring check according to the new parameters (i.e., new introduced AC and AI) and the corresponding broadcast message, the present access attempt is considered as allowed;
(8) UE 101 initials the RACH procedure and the establishment cause for the RACH procedure is set to “setup RRC connection according to that the beam quality is less than the threshold”.

In some implementations, when UE 101 attempts to perform the RACH procedure according to that the beam quality is less than the threshold, BS 102 may directly consider the present access attempt for the RACH procedure as allowed.

In some embodiments, when the RACH procedure is indicated by the PHY layer of UE 101, data of the data transmission stored in a HARQ buffer of HARQ process, which is associated with pre-configured uplink resources for SDT, may need to be kept (i.e., may not be flushed) and may need to be transmitted after the subsequent RACH procedure.

In some embodiments, the trigger condition may include that: (1) the beam quality is less than a threshold; (2) the pre-configured uplink resource(s) is/are not available; or (3) the pre-configured uplink resource(s) is/are released. The data transmission between UE 101 and BS 102 may include SDT or GC based SDT.

Then, whether a fallback to RACH based SDT is supported for the data transmission between UE 101 and BS 102, UE 101 may control, according to the detection of the trigger condition, the data transmission as: (1) stopping SDT and subsequent SDT (or GC based SDT and subsequent GC based SDT); (2) suspending SDT and subsequent SDT (or GC based SDT and subsequent GC based SDT); (3) starting SDT (or GC based SDT); or (4) resuming SDT (or GC based SDT).

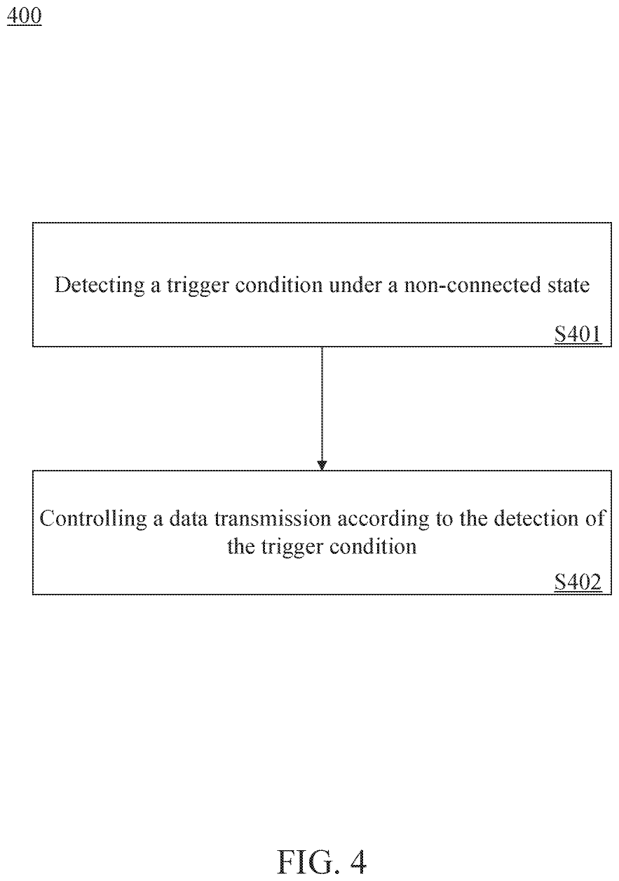

FIG. 4 illustrates a flow chart of a method for wireless communications in accordance with some embodiments of the present application. Referring to FIG. 4, method 400 is performed by a UE (e.g., the UE 101) in some embodiments of the present application.

In some embodiments, operation S401 is executed to detect, by the UE, a trigger condition when the UE is under a non-connected state. The trigger condition may be related to a wireless network characteristic. The trigger condition relating to the wireless network characteristic may include reduction in received beam quality or availability of at least one pre-configured uplink resource. In some implementations, the trigger condition may include that: (1) a beam quality is less than a threshold; (2) the at least one pre-configured uplink resource is not available; or (3) the at least one pre-configured uplink resource is released. Operation S402 is executed to control, by the UE, a data transmission according to the detection of the trigger condition.

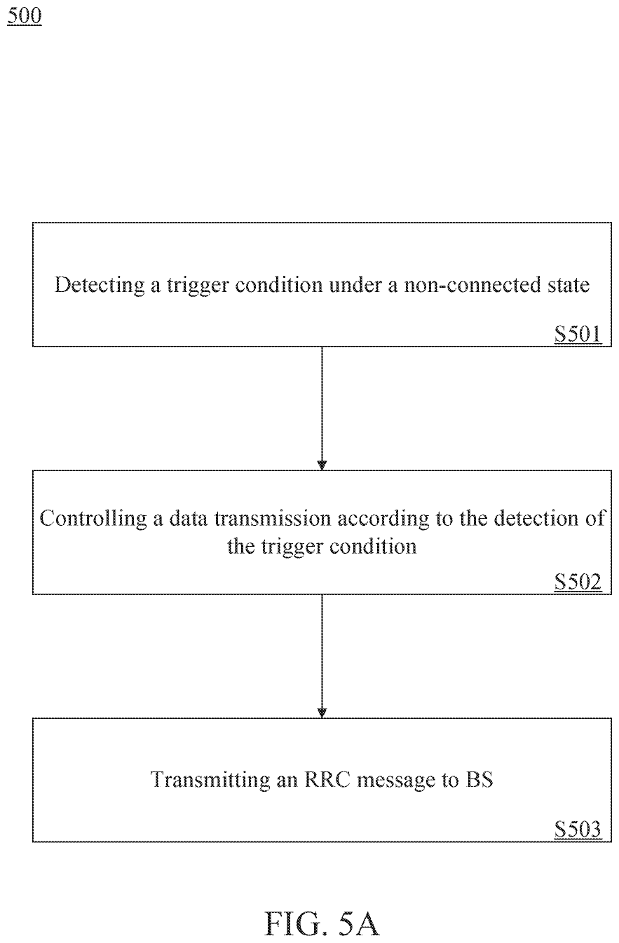

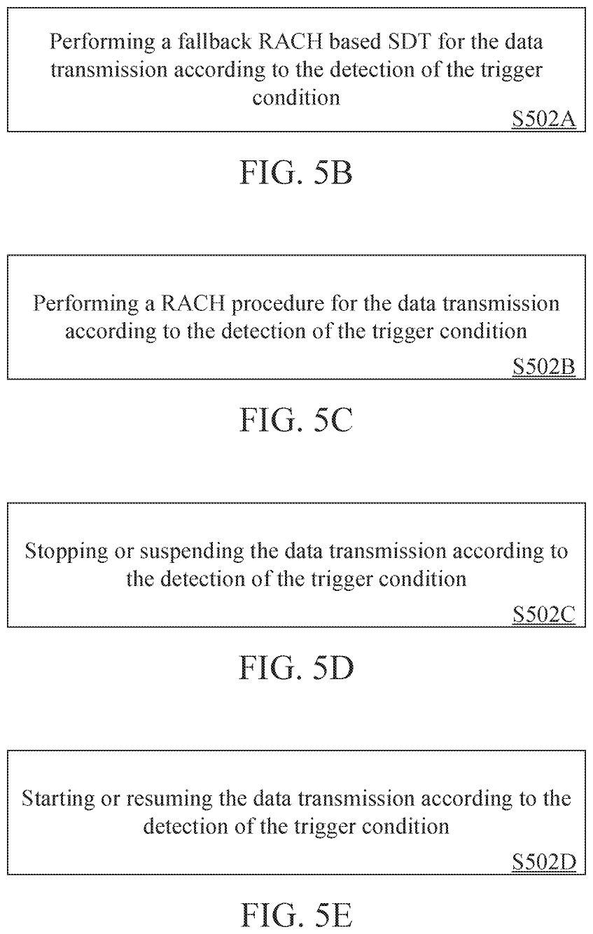

FIGS. 5A to 5E illustrate flow charts of a method for wireless communications in accordance with some embodiments of the present application. Referring to FIGS. 5A to 5E, method 500 is performed by a UE (e.g., the UE 101) in some embodiments of the present application.

In some embodiments, operation S501 is executed to detect, by the UE, a trigger condition when the UE is under a non-connected state. The trigger condition may be related to a wireless network characteristic. The trigger condition relating to the wireless network characteristic may include reduction in received beam quality or availability of at least one pre-configured uplink resource. In some implementations, the trigger condition may include that: (1) a beam quality is less than a threshold; (2) the at least one pre-configured uplink resource is not available; or (3) the at least one pre-configured uplink resource is released.

Operation S502 is executed to control, by the UE, a data transmission according to the detection of the trigger condition. Operation S503 is executed to transmit, by the UE, an RRC message to a BS. The RRC message may include an RRC cause indicating a cause of the control of the data transmission.

In some implementations, the data transmission may include SDT, and operation S502 may include operation S502A when fallback from CG type 1 based SDT to RACH based SDT is supported. Operation S502A is executed to perform, by the UE, a fallback to a RACH based SDT for the data transmission according to the detection of the trigger condition. The RRC cause may indicate that the fallback to the RACH based SDT is performed according to that the beam quality is less than the threshold or the at least one pre-configured uplink resource is not available.

In some implementations, the data transmission may include SDT, and operation S502 may include operation S502B when fallback from CG type 1 based SDT to RACH based SDT is not supported. Operation S502B is executed to perform, by the UE, a RACH procedure according to the detection of the trigger condition. The RRC cause may indicate that the RACH procedure is performed according to that the beam quality is less than the threshold or the pre-configured uplink resources are not available.

In some implementations, the data transmission may include SDT, and operation S502 may include operation S502C whether fallback from CG type 1 based SDT to RACH based SDT is supported. Operation S502C is executed to stop or suspend, by the UE, the data transmission according to the detection of the trigger condition.

In some implementations, the data transmission may include SDT, and operation S502 may include operation S502D whether fallback from CG type 1 based SDT to RACH based SDT is supported. Operation S502D is executed to start or resume, by the UE, the data transmission according to the detection of the trigger condition.

In some implementations, whether fallback from CG type 1 based SDT to RACH based SDT is supported, the RRC cause may indicate that the beam quality is less than the threshold or the pre-configured uplink resources are not available. In some implementations, the RRC cause may include a resume cause value (e.g., parameter “ResumeCause” defined in 3GPP specification) or an establishment cause value (e.g., parameter “EstablishmentCause” defined in 3GPP specification).

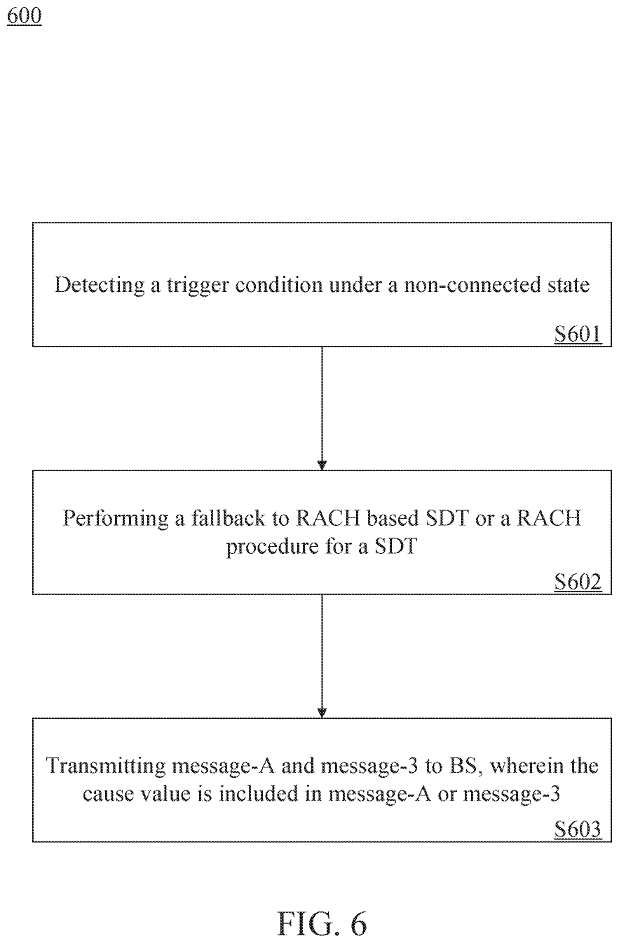

FIG. 6 illustrates a flow chart of a method for wireless communications in accordance with some embodiments of the present application. Referring to FIG. 6, method 600 is performed by a UE (e.g., the UE 101) in some embodiments of the present application.

In some embodiments, operation S601 is executed to detect, by the UE, a trigger condition when the UE is under a non-connected state. The trigger condition may be related to a wireless network characteristic. The trigger condition relating to the wireless network characteristic may include reduction in received beam quality or availability of at least one pre-configured uplink resource. In some implementations, the trigger condition may include that: (1) a beam quality is less than a threshold; (2) the at least one pre-configured uplink resource is not available; or (3) the at least one pre-configured uplink resource is released. Operation S602 is executed to perform, by the UE, a fallback to a RACH based SDT or a RACH procedure for a SDT.

In some implementations, an AC and/or AI may be mapped to an RRC cause. The RRC cause may include a resume cause value. The AC and/or AI mapped to the resume cause value may indicate that present access attempt for the fallback to the RACH based SDT or the RACH procedure is performed according to that the beam quality is less than the threshold. In some implementations, the and/or AI mapped to the resume cause value may indicate that present access attempt is performed according to that the beam quality is less than the threshold.

In some implementations, the RRC cause may include an establishment cause value. The and/or AI mapped to the establishment cause value indicates that present access attempt is performed according to the beam quality is less than the threshold.

Operation S603 is executed to transmit, by the UE, a message-A and message-3 to a BS. The cause value may be included in the message-A or the message-3.

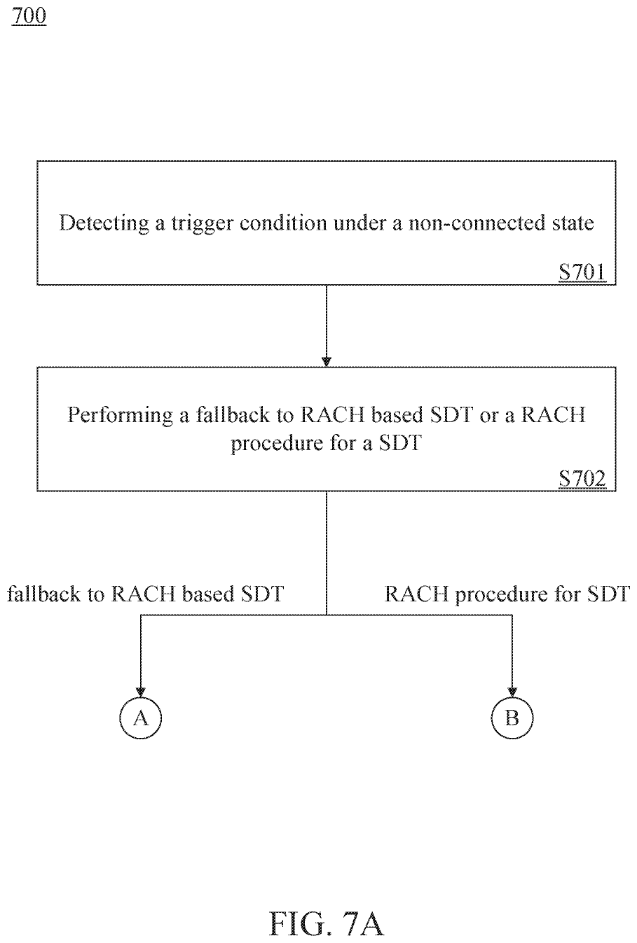

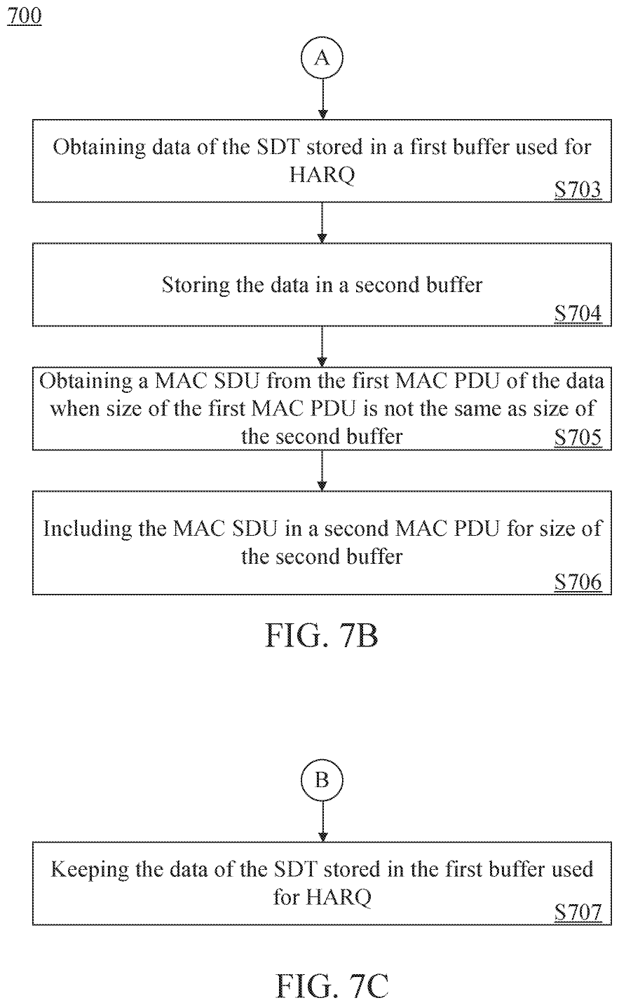

FIGS. 7A to 7C illustrate flow charts of a method for wireless communications in accordance with some embodiments of the present application. Referring to FIGS. 7A to 7C, method 700 is performed by a UE (e.g., the UE 101) in some embodiments of the present application.

In some embodiments, operation S701 is executed to detect, by the UE, a trigger condition when the UE is under a non-connected state. The trigger condition may be related to a wireless network characteristic. The trigger condition relating to the wireless network characteristic may include reduction in received beam quality or availability of at least one pre-configured uplink resource. In some implementations, the trigger condition may include that: (1) a beam quality is less than a threshold; (2) the at least one pre-configured uplink resource is not available; or (3) the at least one pre-configured uplink resource is released. Operation S702 is executed to perform, by the UE, a fallback to a RACH based SDT or a RACH procedure for a SDT.

When operation S702 is executed to perform the fallback to the RACH based SDT, operation S703 is executed to obtain, by the UE, data of the SDT stored in a first buffer used for HARQ. Operation S704 is executed to store, by the UE, the data in a second buffer. In some implementations, the second buffer may be dedicated for message-3 of RACH procedure or message-A of RACH procedure. In some implementations, the second buffer may be dedicated for message-3 of RACH based SDT or message-A of RACH based SDT.

Operation S705 is executed to obtain, by the UE, a MAC SDU from a first MAC PDU of the data when a size of the first MAC PDU is not the same as a size of the second buffer. Operation S706 is executed to include, by the UE, the MAC SDU in a second MAC PDU for the size of the second buffer.

When operation S702 is executed to perform the RACH procedure, operation S707 is executed to keep, by the UE, the data of the SDT stored in the first buffer used for HARQ.

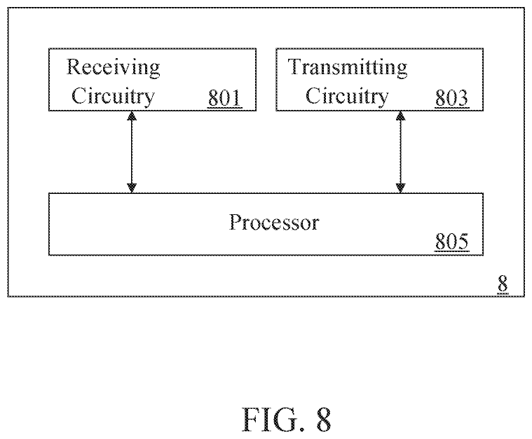

FIG. 8 illustrates an example block diagram of an apparatus 8 according to an embodiment of the present disclosure.

As shown in FIG. 8, the apparatus 8 may include at least one non-transitory computer-readable medium (not illustrated in FIG. 8), a receiving circuitry 801, a transmitting circuitry 803, and a processor 805 coupled to the non-transitory computer-readable medium (not illustrated in FIG. 8), the receiving circuitry 801 and the transmitting circuitry 803. The apparatus 8 may be a UE.

Although in this figure, elements such as processor 805, transmitting circuitry 803, and receiving circuitry 801 are described in the singular, the plural is contemplated unless limitation to the singular is explicitly stated. In some embodiments of the present disclosure, the receiving circuitry 801 and the transmitting circuitry 803 are combined into a single device, such as a transceiver. In certain embodiments of the present disclosure, the apparatus 8 may further include an input device, a memory, and/or other components.

In some embodiments of the present disclosure, the non-transitory computer-readable medium may have stored thereon computer-executable instructions to cause a processor to implement the method with respect to the user equipment as described above. For example, the computer-executable instructions, when executed, cause the processor 805 interacting with receiving circuitry 801 and transmitting circuitry 803, so as to perform the operations with respect to UE depicted in FIG. 1.

Those having ordinary skill in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method of a user equipment, comprising:
detecting a trigger condition relating to a wireless network characteristic, while the user equipment is in a non-connected radio resource (RRC) state with a network device; and
controlling a data transmission according to the detection of the trigger condition.

2. The method of claim 1, wherein the trigger condition relating to the wireless network characteristic includes reduction in received beam quality or availability of at least one pre-configured uplink resource.

3. The method of claim 2, wherein the controlling the data transmission according to the detection of the trigger condition comprises:
performing a fallback to a random access channel (RACH) based small data transmission (SDT) for the data transmission according to the detection of the trigger condition;
performing a RACH procedure for the data transmission according to the detection of the trigger condition;
stopping or suspending the data transmission according to the detection of the trigger condition; or
starting or resuming the data transmission according to the detection of the trigger condition.

4. The method of claim 3, further comprising:
transmitting a radio resource control (RRC) message to the network device, wherein the RRC message includes an RRC cause indicating a cause of the control of the data transmission.

5. (canceled)

6. (canceled)

7. The method of claim 3, wherein an access category is mapped to an RRC cause indicating a cause of the control of the data transmission.

8. (canceled)

9. (canceled)

10. The method of claim 3, wherein an access identity is mapped to an RRC cause indicating a cause of the control of the data transmission.

11. (canceled)

12. (canceled)

13. (canceled)

14. (canceled)

15. An apparatus, comprising:
a receiving circuitry;
a transmitting circuitry; and
a processor coupled to the receiving circuitry and the transmitting
circuitry configured to cause the apparatus to:
detect a trigger condition relating to a wireless network characteristic, while the apparatus is in a non-connected radio resource (RRC) state with a network device, and
control a data transmission according to the detection of the trigger condition.

16. The apparatus of claim 15, wherein the trigger condition relating to the wireless network characteristic includes reduction in received beam quality or availability of at least one pre-configured uplink resource.

17. The apparatus of claim 16, wherein to control the data transmission according to the detection of the trigger condition comprises to:
perform a fallback to a random access channel (RACH) based small data transmission (SDT) for the data transmission according to the detection of the trigger condition;
perform a RACH procedure for the data transmission according to the detection of the trigger condition;
stop or suspend the data transmission according to the detection of the trigger condition; or
start or resume the data transmission according to the detection of the trigger condition.

18. The apparatus of claim 17, wherein the processor is configured to cause the apparatus to:
transmit a radio resource control (RRC) message to the network device, wherein the RRC message includes an RRC cause indicating a cause of the control of the data transmission.

19. The apparatus of claim 18, wherein the RRC cause indicates that:
the fallback to the RACH based SDT is performed according to that a beam quality is less than a threshold or the at least one pre-configured uplink resource is not available;
the RACH procedure is performed according to that the beam quality is less than the threshold or the at least one pre-configured uplink resource is not available; or
the beam quality is less than the threshold or the at least one pre-configured uplink resource is not available.

20. The apparatus of claim 18, wherein the RRC cause includes a resume cause value or an establishment cause value.

21. The apparatus of claim 17, wherein an access category is mapped to an RRC cause indicating a cause of the control of the data transmission.

22. The apparatus of claim 21, wherein the RRC cause includes a resume cause value, and the access category mapped to the resume cause value indicates that:
an access attempt for the fallback to the RACH based SDT is performed according to that a beam quality is less than a threshold;
the access attempt for the RACH procedure is performed according to that the beam quality is less than the threshold; or
the access attempt is performed according to that the beam quality is less than the threshold.

23. The apparatus of claim 21, wherein the RRC cause includes an establishment cause value, and the access category mapped to the establishment cause value indicates that an access attempt is performed according to a small data transmission beam failure recovery.

24. The apparatus of claim 17, wherein an access identity is mapped to an RRC cause indicating a cause of the control of the data transmission.

25. The apparatus of claim 24, wherein the RRC cause includes a resume cause value, and the access identity mapped to the resume cause value indicates that:
an access attempt for the fallback to the RACH based SDT is performed according to that a beam quality is less than a threshold;
the access attempt for the RACH procedure is performed according to that the beam quality is less than the threshold; or
the access attempt is performed according to that the beam quality is less than the threshold.

26. The apparatus of claim 24, wherein the RRC cause includes an establishment cause value, and an access identity number mapped to the RRC cause indicates that access attempt is performed according to a small data transmission beam failure recovery.

27. The apparatus of claim 17, wherein the processor is configured to cause the apparatus to:
obtain data of the data transmission stored in a first buffer used for hybrid automatic repeat request (HARQ) when the fallback to the RACH based SDT is performed; and
store the data in a second buffer, wherein the second buffer is used for message-3 of RACH, message-A of RACH, message-3 of RACH based SDT or message-A of RACH based SDT.

28. The apparatus of claim 27, wherein the data includes a first media access control protocol data unit (MAC PDU), and wherein the processor is configured to cause the apparatus to:
obtain a media access control service data unit (MAC SDU) from the first MAC PDU when a size of the first MAC PDU is not a same size as a size of the second buffer; and
include the MAC SDU in a second MAC PDU for the size of the second buffer.
